(19) United States
(12) Patent Application Publication
(10) Pub. No.: US 2012/0183786 A1
(43) Pub. Date: Jul. 19, 2012

(54) ANTI-FOG COATING, SUBSTRATE HAVING SAME AND PROCESS FOR PRODUCING SAME

(76) Inventors: Gaétan Laroche, Quebec (CA); Christian Sarra-Bournet, Quebec (CA); Pascale Chevalier, Quebec (CA); Nicolas Gherardi, Ramonville Saint-Agne (FR); Louison Maechler, Fontaine (FR)

(21) Appl. No.: 13/325,689

(22) Filed: Dec. 14, 2011

Related U.S. Application Data
(60) Provisional application No. 61/423,141, filed on Dec. 15, 2010.

(51) Int. Cl. B32B 9/04; B05D 5/00; B32B 17/06; B05D 3/10

(52) U.S. Cl. 428/429; 427/340; 427/569; 427/578; 428/447

(57) ABSTRACT

The invention relates to an anti-fog coating, process for producing anti-fog coating at the surface of a substrate such as a thermoplastic polymer and a substrate having anti-fog coating thereon.

This application claims priority to U.S. Provisional Patent Application Ser. No. 61/423,141 filed Dec. 15, 2010, herein incorporated by reference in its entirety.

### FIELD OF THE INVENTION

The invention relates to an anti-fog coating, process for producing anti-fog coating at the surface of a substrate such as a thermoplastic polymer and a substrate having anti-fog coating thereon.

### BACKGROUND OF THE INVENTION

As it is well known, fog occurs when water vapor condenses onto surfaces and forms discrete dispersed water particles which are large enough to scatter light, thereby restricting light transmission and optical efficiency.

One of the key factors in the formation of moisture-drop deposition is the surface energy of the polymer of the substrate. The prevention of fogging can thus be assessed by the high surface energy of hydrophilic materials, as the water film is homogeneously dispersed over the surface rather than forming fog drops. Hydrophilic properties can be obtained by coating polymers or monomers that contain hydrophilic functionalities, such as hydroxyl (OH) or carboxyl groups (COOH, COOR), onto surfaces.

The problem of fogging is omnipresent as it frequently occurs on eyeglasses, goggles, face shields, and binoculars. Moreover, surface fog reduces the efficiency of analytical and medical instruments and is also a nuisance in other domains, such as food packaging and electronic applications.

Films obtained by UV or thermic polymerization of monomer solutions are applied to visors, helmets, ski and protection goggles but they also show limited resistance and their anti-fog properties rapidly fade out.

Therefore, there is a need for new process providing an anti-fog coating for applications on thermoplastic polymers used in optical accessories and instruments and the other domains described above.

### SUMMARY OF THE INVENTION

In one aspect, there is provided an anti-fog coating for a surface of a substrate comprising in order:
a layer of Formula I: SiOxCyNz:H;
a layer of Formula II: SiOw:H;
a layer of Formula I: SiOxCyNz:H;
a layer resulting from contacting a polyanhydride polymer with the outermost layer of Formula I; and
a layer resulting from contacting a hydrophilic polymer;

wherein x, y and z in each layers of Formula I are the same or different.

In another aspect, there is provided a process for preparing an anti-fog coating to a surface of a substrate comprising:
a) depositing a layer of Formula I: SiOxCyNz:H, on the surface of the substrate;
b) depositing a layer of Formula II: SiOw:H, on the layer of Formula I;
c) depositing a layer of Formula I: SiOxCyNz:H, on the layer of Formula II; and
d) adding a polyanhydride polymer on the outermost layer of Formula I; and
e) adding a hydrophilic polymer on the polyanhydride polymer;

wherein x, y and z in each layers of Formula I are the same or different.

In yet another aspect, there is provided a substrate having an anti-fog coating thereon, said coating comprising in order:
a layer of Formula I: SiOxCyNz:H;
a layer of Formula II: SiOw:H;
a layer of Formula I: SiOxCyNz:H;
a layer resulting from contacting a polyanhydride polymer with the outermost layer of Formula I; and
a layer resulting from contacting a hydrophilic polymer;

wherein x, y and z in each layers of Formula I are the same or different.

### BRIEF DESCRIPTION OF THE DRAWINGS

FIG. 1 represents a spin-coating protocol for the addition of PEMA and PVA;

FIG. 2 is a XPS depth profile of a combination of a layer of Formula I and a layer of Formula II;

FIG. 3 is a FTIR spectra between 2600 and 3800 cm⁻¹ of a layer of Formula I in accordance with one embodiment of the present disclosure;

FIG. 4 is an ATR-FTIR spectrum of (a) a Si-containing multilayer film on a polycarbonate substrate, (b) a Si-containing multilayer film and PEMA coating on a polycarbonate substrate, and (c) a Si-containing multilayer film, a PEMA and PVA coatings on a polycarbonate substrate;

FIG. 5a is a C1s high resolution XPS spectrum of a Si-containing multilayer film on a polycarbonate substrate;

FIG. 5b is a C1s high resolution XPS spectrum of a Si-containing multilayer film and PEMA coating on a polycarbonate substrate;

FIG. 5c is a C1s high resolution XPS spectrum of a Si-containing multilayer film, a PEMA and PVA coatings on a polycarbonate substrate; and

FIG. 6 is an optical transmittance of a polycarbonate substrate having an anti-fog coating thereon in accordance with one embodiment of the present disclosure.

FIG. 7 is a schematic drawing showing a process for producing an anti-fog coating at the surface of a substrate. The process comprises adding polyvinyl alcohol (PVA) and poly(ethylene-maleic anhydride) (PEMA) to a polycarbonate (PC) substrate coated with a silicon (Si)-containing multilayer film.

### DETAILED DESCRIPTION OF THE PREFERRED EMBODIMENT

While the making and using of various embodiments are discussed below, it should be appreciated that the specific embodiments discussed herein are merely illustrative of specific ways of making and using the invention and should not be construed as to limit the scope of the invention.

In one embodiment, the layers of Formulae I and II are deposited by plasma deposition. These may be deposited on the substrate by using dielectric barrier discharge procedure such as atmospheric pressure Townsend discharge (ATPD) procedure.

In one embodiment, the layer of Formula I is represented by: SiOxCyNz:H. In still a further embodiment, the values of x, y and z are not especially limited, however z should be equal or greater than 0.1. Examples include, but are not limited to, SiO_{1.39}C_{0.85}N_{0.23}:H, SiO_{1.28}C_{1.02}N_{0.27}:H, SiO_{1.28}C_{1.56}N_{0.51}:H. The innermost layer of Formula I is believed to provide compatibility between the polymer substrate and the layer of Formula II. The innermost layer is the layer of Formula I that is closest to the substrate. The outermost layer of Formula I may be the same or different than any preceding layer of formula I such as the innermost layer of Formula I. This outermost layer is believed to provide nucleophilic groups for binding with a polyanhydride polymer. The chemical nature of the layer of formula I can be varied in a gradient across its thickness so that the compatibility between same and the substrate and/or composition is improved. For example, if the layer is to be applied on a substrate which has an <<organic>> character and further coated by a layer having an <<inorganic>> character, the composition of the layer of formula I can be varied to initially be more compatible with the substrate and gradually become more compatible with the inorganic coating. Conversely, if the layer of formula I is to be deposited on a layer of <<inorganic>> character followed by coating with an <<organic>> character, the gradient in the layer of formula I will be reversed having regard to that previously described.

In one embodiment, the layer of Formula I may be deposited on the substrate by using a siloxane or silazane in the presence of a carrier gas containing nitrogen such as N₂. Examples of siloxanes include, but are not limited to alkyl siloxanes such as hexaalkylsiloxanes including hexamethyldisiloxane (HMDSO), or polydimethylsiloxane (PDMS), tetramethylcyclotetrasiloxane (TMCTS), octamethylcyclotetrasiloxane, tetraethylorthosilicate (TEOS), polyhydrogenmethylsiloxane and tetramethyldisiloxane (O'Neil, L. O'Hare, L A, Leadley, S R, Goodwin A J (2005) Chemical Vapor Deposition 11:477). An example of silazane includes hexamethydisilazane (HMDSN). The siloxane or silazane content may be in the range of 1 to 1000 ppm, e.g. partial pressure range of 0.1 to 100 Pa.

In one embodiment, the thickness of a layer of Formula I may be at least about 50 nm or from about 50 to 100 nm. The thickness is preferably sufficient to ensure a complete coating of the surface and allow for making a gradient across the thickness as described above. The coating should however be sufficiently thin from an optical view point.

In one embodiment, the layer of Formula II is represented by: SiOw:H. Preferably, w is about 2. The layer of Formula II is preferably deposited on a layer of Formula I. Examples include, but are not limited to, SiO_{2.2}:H, SiO_{2.18}:H. This layer may provide hardness properties to the anti-fog coating and may protect the polymer substrate from reacting or dissolving in solvents which may be used in the following steps, such as spin-coating process. The layer of Formula II may further provide low surface roughness and may constitute a protective coating film against mechanical scratches. This atmosphere may permit limiting gas diffusion through the layers of the anti-fog coating.

In one embodiment, the layer of Formula II may be deposited on a layer of Formula I by using a siloxane or a silane in the presence of a carrier gas containing nitrogen such as N₂ and an oxidizing gas. Examples of siloxane include, but are not limited to alkyl siloxanes such as hexaalkylsiloxanes including hexamethyldisiloxane (HMDSO) or tetramethylcyclotetrasiloxane (TMCTS). An example of silane includes tetraetoxysilane (TEOS). The siloxane or silane content may be in the range of 1 to 1000 ppm, e.g. partial pressure range of 0.1 to 100 Pa). Examples of oxidizing gas include, but are not limited to N₂O and O₂. H₂O can also be used. Regarding the oxidizing gas, the concentration must be greater than that of the siloxanes or silanes to ensure that a layer of inorganic character is obtained. A possible ratio of oxidizing gas/siloxanes or silanes is about 12. For example, a possible ratio of N₂O/HMDSO is about 12.

In one embodiment, the thickness of a layer of Formula II should be sufficient to provide a “barrier” effect such as at least 50 nm. See for example N. Gherardi, L. Maechler, C. Sarra-Bournet, N. Naudé, F. Massines, APGD and APTD for the deposition of silicon based thin films from N₂O/HMDSO mixtures: application to gas-barrier layers [19th International Symposium on Plasma Chemistry, Bochum, Germany, Jul. 26-31, 2009].

In one embodiment, the steps a) and b) comprising the deposition of the layers of Formulae I and II may be repeated resulting in a bi-layer sequence.

In one embodiment, once the polyanhydride polymer has been added on the outermost layer of Formula I, the hydrophilic polymer having anti-fog properties is added.

In one embodiment, the polyanhydride polymer and hydrophilic polymer may be added on the outermost layer of Formula I in one step by adding one solution comprising both.

Polyanhydride polymers have the ability to covalently bind with the nucleophilic groups which may be provided by the outermost layer of Formula I as well as bind the hydrophilic polymer. Polyanhydride polymers further have the property of cross-linking which allows for an increased of cohesion and therefore of stability between the molecules and the surface.

The polyanhydride polymers useful in the present invention are not particularly limited and include without limitation any alternate (alt) or sequential (co)polyanhydride polymers, that possess a sufficient number of anhydride functions to allow bonding between the nucleophilic groups of the outermost layer of Formula I and the hydrophilic polymer.

In one embodiment, the polyanhydride polymer is selected from poly(ethylene-alt maleic anhydride), poly(maleic anhydride-alt-1-octadecene), poly(isobutylene-alt-maleic anhydride), poly(styrene-alt-maleic anhydride), poly(methyl vinyl ether-alt-maleic anhydride) and poly[(isobutylene-alt-maleic acid, ammonium salt)-co-(isobutylene-alt-maleic anhydride)].

In a further embodiments: the polyanhydride polymer is poly(ethylene-alt maleic anhydride).

Table 1 shows typical polyanhydride polymers, their monomeric structures and some physico-chemical properties.

TABLE 1

| Polyanhydride polymer | Solubility | Mw orMn |
|---|---|---|
| Poly(ethylene-alt-maleic anhydride) 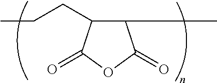 PEMA | 10% w/v acetone DMF | M_{w} 100,000- 500,000, |
| Poly(isobutylene-alt-maleic anhydride) 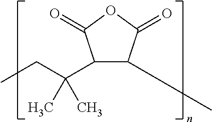 PIMA | DMF | M_{w}~60,000 |
| Poly(octadecene-alt-maleic anhydride) 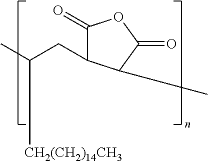 POMA | 7% w/v THF DMF | Mₙ 30,000- 50,000 |
| Poly[(isobutylene-alt-maleic acid, ammonium salt)- co-(isobutylene-alt-maleic anhydride)] 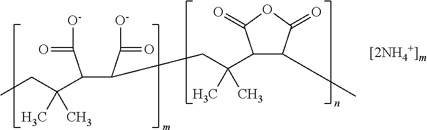 PMA-NH₃ | 5% w/v H₂O | Mw~60,000 |
| Poly(methyl vinyl ether-alt-maleic anhydride) 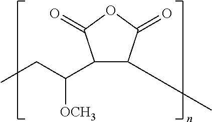 PMVE-MA | 5% w/v DMF THF | Mw~216,000 average Mn~80,000 |
| Poly(styrene-co-maleic anhydride) 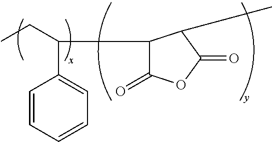 PS-MA | DMF THF Acétone | maleic anhydride 14 wt. % |

In one embodiment, the polyanhydride polymer is applied by spin coating.

In one embodiment, the polyanhydride polymer is applied by dip coating.

Although reference was made to spin or dip coatings of the polyanhydride polymers, one of skill in the art will appreciate that various/other deposition techniques are contemplated, including without limitation spraying, electrospray, flow coating, roll coating, brushing and plasma deposition

The hydrophilic polymers having anti-fog properties useful in the present invention are not particularly limited as far as they provide anti-fog properties when added on the polyanhydride polymer. Typically, these polymers have nucleophilic groups such as hydroxyl, that are able to react with an anhydride function.

In one embodiment, the hydrophilic polymer is selected from polyvinyl alcohol, partially hydrolyzed polyvinyl ester, partially hydrolyzed polyvinyl ether and cellulose derivatives.

In one embodiment, the hydrophilic polymer is polyvinyl alcohol or partially hydrolyzed polyvinyl ester.

In one embodiment, the hydrophilic polymer is cellulose derivative selected from methyl cellulose, 2-hydroxyethyl cellulose, cellulose acetate, methyl 2-hydroxyethyl cellulose, chitosan and their mixtures thereof.

In one embodiment, the hydrophilic polymer is cellulose derivative selected from methyl cellulose, 2-hydroxyethyl cellulose, chitosan and their mixtures thereof.

Table 2 shows typical hydrophilic polymers having anti-fog properties that can be bonded to the polyanhydride polymer.

TABLE 2

| Hydrophilic polymers | Solubility | Mw ou Mn |
|---|---|---|
| Polyvinyl alcohol, 98-99% hydrolyzed 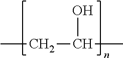 PVA 98% | 1% w/v H₂O | M_{w} 85,000- 124,000 |
| Poly(vinyl alcohol), 87-89% hydrolyzed 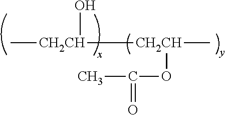 PVA 87% | 2% w/v H₂O | Mw 146,000- 186,000 |
| Poly(styrene-co-allyl alcohol) allyl alcohol 40 mol %-Hydroxyl value 255 mg/KOH [—CH₂CH(C₆H₅)—]ₓ[—CH₂CH(CH₂OH)—]_{y} PS-AA | 7% w/v DMF 7% w/v THF 8% w/v acetone | Mw~2,200 Mn ~1,200 |
| Methyl cellulose 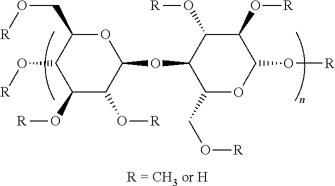 MeCell | 1% w/v H₂O | Mₙ~40,000 |
| 2-Hydroxyethyl cellulose 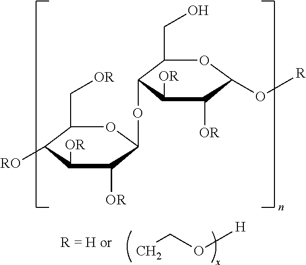 HOCell | 5% w/v H₂O | Mᵥ~90,000 |
| Cellulose acetate-39.7 wt. % acetyl 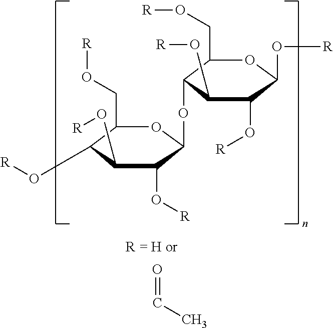 AcetCell | 5% w/v H₂O 4% w/v DMF 4% w/v THF 4% w/v acetone | Mₙ~60,000 |
| Methyl 2-hydorxyethyl cellulose 8 wt. % HO(CH₂)₂, 26 wt. % CH₃O 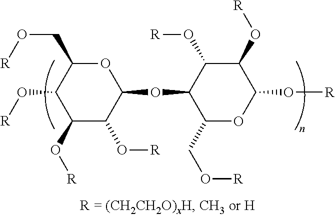 MeOHCell | 2% w/v H₂O | 0.06-0.50 mol HO(CH₂)₂/mol cellulose 1.3-2.2 mol CH₃/mol cellulose |
| Chitosan, medium molecular weight 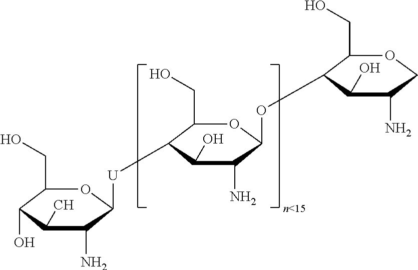 Chitosan | 1% w/v solution in 1% acetic acid | Medium molecular weight |

In one embodiment, the hydrophilic polymer (polymer having anti-fog properties) is bonded to the polyanhydride polymer by spin coating.

In one embodiment, the hydrophilic polymer (polymer having anti-fog properties) is bonded to said anhydride polymer layer by dip coating.

Although reference was made to spin or dip coatings of the hydrophilic polymers, one of skill in the art will appreciate that various/other deposition techniques are contemplated, including without limitation spraying, electrospray, flow coating, roll coating, brushing and plasma deposition.

In one embodiment, the process is further comprising the step of cross-linking said anhydride polymer.

In one embodiment, the process is further comprising the step of cross-linking said hydrophilic layer.

In one embodiment, the process is further comprising the step of cross-linking said anhydride and hydrophilic polymers.

From the above, it will be understood that the cross-linking of said anhydride and hydrophilic polymers can be conducted either after the respective step of addition or after both have been applied.

In one embodiment, the step of cross-linking is conducted by heating or exposing to U.V. light. Alternatively other radiation sources may be used (I.R. visible light). In one embodiment, a cross linking agent may be used alone and/or in addition to heating or exposing to light.

A skilled person will understand that an additional step of the present process may further comprise one or more washing and/or drying between each bonding steps to remove the non-covalently bonded polymer.

The substrate is not particularly limited and comprise those that would benefit from being provide anti-fog properties while not being detrimentally affected by the process described herein. The substrate may include polymers, glass, ceramics, metals, composites and combinations thereof. Non-limiting examples of plastics include CR39 (allyl diglycol carbonate), polycarbonates, polyurethanes, polyamides, and polyesters. Non-limiting examples of glass include windows and optical elements. Non-limiting examples of ceramics include transparent armour. Non-limiting examples of metals include metallic mirrors.

In one embodiment, the substrate may be a polymer substrate including, but is not limited to, polycarbonate, polyethylene, polypropylene, polystyrene, poly(ethylene terephtalate), and Plexiglas. For example, the polymer substrate may be a thermoplastic polymer substrate.

The coated substrate obtained in accordance with the process of the disclosure may be part of or be articles to which the coating composition can be applied are not especially limited and include optically clear articles such as protective eyewear (goggles, face shields, visors, etc.), ophthalmic lenses, automobile windshields, windows, and the like.

In one embodiment, at least one surface of the substrate is coated with the anti-fog coating defined herein.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

### EXAMPLES

### Materials

The following materials have been in the examples described below. Commercial polycarbonate (PC), 125 μm in thickness, was purchased from Goodfellow Corporation (Lille, France). The gases used for the APTD process were nitrogen (99.998% purity) and nitrous oxide (99.998% purity) purchased from Air Liquid (Toulouse, France). The monomer hexamethyldisiloxane (HMDSO) was purchased from Fluka (Saint-Quentin-Fallavier, France), while the poly(ethylene-alt-maleic anhydride) (PEMA; Mw=100,000-500,000) and poly(vinyl alcohol) (PVA; Mw=84,000-124,000), with a 98% level of hydrolization, were purchased from Sigma-Aldrich (Oakville, ON, Canada) and used without further purification. The acetone was purchased from Laboratoire MAT (Montréal, QC, Canada). The amine surface concentration was determined with a chemical derivatization method using 98% chlorobenzaldehyde (Sigma-Aldrich).

### Example 1

### Deposition Process of a Layer of Formula I

The Dielectric Barrier Discharge (DBD) was ignited at atmospheric pressure between two parallels electrodes (10 cm²) made of metalized paint deposited on alumina plates as described in Massines F, Gherardi N, Formelli A, Martin S (2005) Surf Coat Tech 200: 1855.

The layer of Formula I was deposited without N₂O in the gas phase. To obtain an Atmospheric Pressure Townsend Discharge (APTD), the gas gap was fixed at 1 mm, and the discharge was induced by AC high voltage at 3 kHz. The power dissipated in the discharge (5 W/cm³ for 15 kVₚₖ₋ₚₖ applied to the electrodes) was calculated from current and voltage measurements. Using such conditions (discharge power and N₂ gas flow rate), the gas temperature did not rise more than 20K (Naudé N, Gherardi N, Es-Sebbar E, Cambronne J-P, Massines F. Electrical model of an atmospheric pressure townsend-like disdcharge (APTD): Application of the determination of the gas temperature. in Plasma Chemistry (HAKONE IX). 2004. Padova, Italy), keeping the substrate temperature during deposition lower than 320 K.

A gas flow of a mixture of HMDSO diluted in N₂ was brought between the two alumina plates to continuously renew the atmosphere. A vapor source controller (Bronkhorst, Montigny-lès-Cormeilles, France) was used to deliver the necessary HMDSO flow rate at room temperature and the gas flows were regulated by means of mass flow meters.

To obtain a film with a homogeneous thickness on a large area, the cell was equipped with a roll-to-roll foil transport system. The thickness of the various layers was carefully controlled to prevent excessive optical absorbance of visible wavelengths while preserving the barrier properties of the multilayer. For the plasma deposition process, the film displacement speed was determined in order to reach the desired thickness while maintaining a given gas composition and power dissipated in the discharge. Hence, using the pre-cited discharge conditions, the film displacement speed was fixed at 0.66 cm/min to obtain a 50 nm-thick layer of Formula II (dynamic growth rate ˜33 nm·cm/min) and at 1 cm/min so as to deposit a 80 nm-thick of the outermost layer of the Formula I (dynamic growth rate ˜80 nm·cm/min).

### Example 2

### Deposition Process of a Layer of Formula II on the Substrate Resulting from Example 1

The deposition standard conditions consisted of using 10 ppm HMDSO and 240 ppm N₂O diluted in N₂ flowing at 3.5 litres per minute. N₂O may be chosen over O₂ as the oxidizing gas because it improves the stability of the discharge (Gherardi N, Naudé N, Es-Sebbar E, Enache I, Caquineau H, Massines F. Transition from Atmospheric Pressure Townsend Discharge (APTD) to filamentary discharge in N₂/O-containing mixtures. in Plasma Chemistry (HAKONE X). 2006. Saga, Japan).

### Example 3

### Deposition of a Layer of Formula I on the Substrate Resulting from Example 2

A layer of Formula I was deposited using the same steps as described in Example 1 above.

### Example 4

### Addition of an Anhydride Polymer (poly(ethylene-maleic anhydride) (PEMA)) and a Hydrophilic Polymer (Polyvinyl Alcohol (PVA))

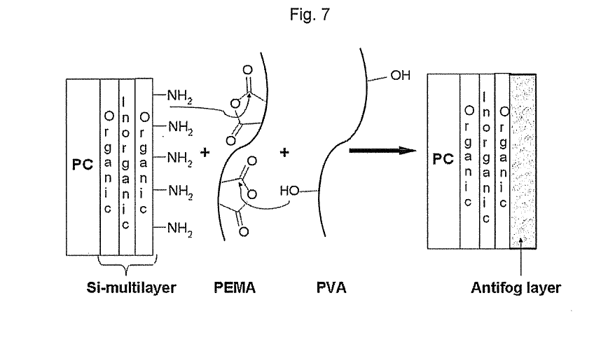

In this example, the polyanhydride polymer was poly(ethylene-maleic anhydride) (PEMA). Then, the polyvinyl alcohol (PVA) is bonded to the polyanhydride polymer resulting from the addition of PEMA to the outermost layer of Formula I (FIG. 7).

The polymer solutions, consisting of poly(ethylene-alt-maleic anhydride)-0.1% (w/v) in acetone and poly(vinyl alcohol)-1% (w/v) in deionized water, were deposited by means of a spin-coating apparatus (Single Wafer Spin processor, model WS-400B-6NPP/LITE/AS2—Laurell Technologies Corp., North Wales, Pa., USA). The rotation speed protocol was set to take into account the polymer solution viscosity and solvent evaporation rate and was optimized to obtain appropriate layer thicknesses (FIG. 1). The spin-coating process was performed under ambient conditions. Following deposition, the samples were subjected to a thermal post-treatment at 85° C. in a vacuum heat oven to complete the reticulation process of the polymer coatings.

### Example 5

### Procedure for the Thickness Analyses

Film thickness was measured by profilometry using a TENCOR P2 stylus profilometer (Filmetrics, San Diego, Calif., USA) with a vertical resolution of 25 Å. Atomic force microscopy (AFM) investigations were also performed using the tapping mode of a Dimension™ 3100 atomic force microscope (Veeco, Woodbury, N.Y., USA) with an etched silicon tip (OTESPA™, tip radius<10 nm, aspect ratio 1.6/1). Surface topography was determined for areas of 20×20 μm. The AFM images were analyzed using WS×M 3.0 Beta 12.4 image browser software (Horcas I, Fernández R, Gomez-Rodriguez J M, Colchero JG-H, J., Baro A M (2007) Rev Sci Instrum 78: 013705).

### Example 6

### Procedure for the Hardness Analyses

Hardness measurements were carried out using the same AFM in nanoindentation mode with a PNISDP Berkovich diamond nanoindentation tip (Veeco, Santa Barbara, Calif., USA) equipped with a cantilever spring constant of 279 N/m and a tip radius of <50 nm according to the manufacturer's specifications. All of the hardness measurements were performed using the same tip with a load of 0.1 mN.

### Example 7

### Procedure for Analyzing the Chemical Composition of the Surface

Surface chemical composition was investigated using X-ray photoelectron spectroscopy (XPS) following each step of PC surface modification, using a PHI 5600-ci spectrometer (Physical Electronics, Eden Prairie, Minn., USA). A monochromatic aluminium X-ray source (1486.6 eV) at 300 W with neutralizer was used to record the survey spectra (0-1400 eV), while the high resolution spectra were obtained using a monochromatic magnesium X-ray source (1253.6 eV) at 300 W with no charge neutralization. The detection was performed at 45° with respect to the surface normal and the analyzed area was 0.005 cm². Sputtering for depth analyses was performed with an Ar⁺ ion beam of 4 KeV energy and 0.6 μA/cm² current density at an incident angle of 45° over a surface of ˜0.2 cm².

### Example 8

### Procedure for Analyzing the Amine Concentration of the Surface

Amine surface concentration was quantified using chemical derivatization with chlorobenzaldehyde, as described in Chevallier P, Castonguay M, Turgeon S, Dubrulle N, Mantovani D, McBreen P H, Wittmann J C, Laroche G (2001) J Phys Chem B 105: 12490. Briefly, the derivatization reaction was performed in the vapor phase at 40° C. for 2 h in a sealed glass tube in which a 1 cm-thick bed of soda-lime glass beads was placed to separate the reagent from the reactive surfaces. These surfaces were then outgassed under vacuum overnight prior to XPS analysis.

### Example 9

### Procedure for Analyzing the Chemical Composition and Structure of the Films

The chemical composition and structure of the films were also characterized by ATR-FTIR spectroscopy using a Nicolet Magna 550 spectrometer (Thermo-Nicolet, Madison, Wis., USA), with a 4 cm⁻¹ resolution equipped with a split pea attachment (Harrick Scientific Corp., Ossining, N.Y., USA) and a silicon hemispherical 3 mm-diameter internal reflection element.

Transmittance spectra in the visible wavelength (300-900 nm) were recorded using a UV-visible spectrophotometer (UV-1601, Man-Tech Associates Inc., Shimadzu—Guelph, ON, Canada). The chemical analyses and optical transmission experiments were all performed on a substrate.

### Results and Discussion of the Anti-Fog Coating Characterization

The chemical composition of the layer of Formula II and the layers of Formula I was determined by XPS using a depth analysis (FIG. 1) which demonstrates that the combined layers may be obtained by plasma deposition using the roll-to-roll technique. The thickness of the combined layer of Formula II and the layers of Formula I was set to 50 nm and 80 nm, respectively. The apparent disagreement between the layer thicknesses measured during plasma deposition and the sputtering data emanate from the fact that sputtering rates are generally higher in carbon-containing materials (Hegemann D, U.S, Oehr C, RF-Plasma Deposition of SiOx and a-C:H as Barrier Coatings on Polymers, in Plasma Processes and Polymers, R. d'Agostino P F, C. Oehr and M. R. Wertheimer, Editor. 2003, Wiley InterScience. p. 23). It is likely that the sputtering rate of the layer of Formula II was approximately 0.5 nm/min, and that of the layer of Formula I closer to 1 nm/min.

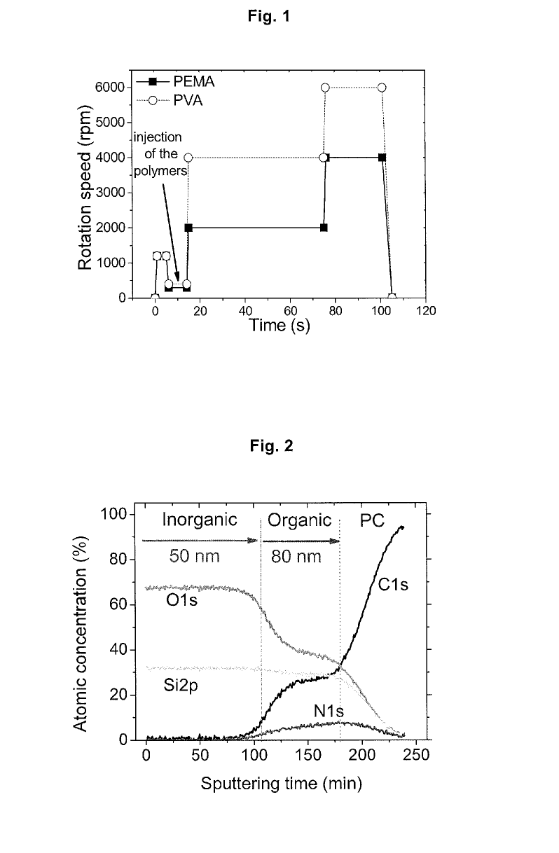

As illustrated in FIG. 2, the atomic concentration value of each plateau is characteristic of the chemical composition of each layer. For the innermost layer of Formula I, the so-called plateau was reached after a sputtering time of 140 min, thus permitting to estimate the layer stoichiometry to be SiO_{1.39}C_{0.85}N_{0.23}:H. It should be emphasized that the layer of Formula I/polycarbonate substrate interface revealed a modification of the substrate, as nitrogen and silicon were observed in the substrate (after 190 min of sputtering). In the case of the layer of Formula II, the composition was homogeneous, with a stoichiometry of SiO_{2.2}:H, regardless of the sputtering time. This stoichiometry (O/Si ˜2.2) was previously attributed to the presence of silanol groups (Si—OH) which have already been evidenced by FTIR analyses (Massines F, Gherardi N, Formelli A, Martin S (2005) Surf Coat Tech 200: 1855, Fracassi F, D'Agostino R, Favia P (1992) J Electrochem Soc 139: 2636, Paparazzo S, Fanfoni M, Severini E (1992) J Vac Sci Technol A: 2892). Moreover, as expected, the addition of N₂O during the plasma process led to a layer of Formula II with no incorporation of N. Similar observations are reported in other studies.

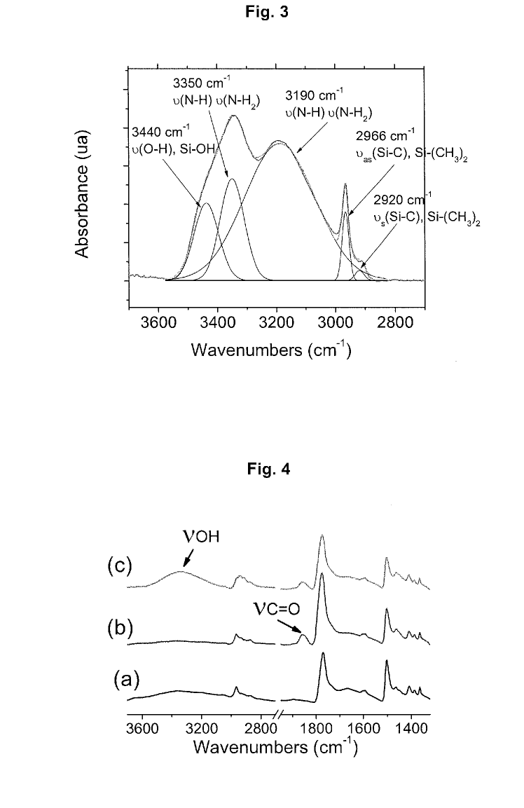

The FTIR transmission spectrum of the layer of Formula I deposited on a silicon wafer confirmed the presence of both amine and amide groups. The wide absorption band between 2800 and 3800 cm⁻¹ displayed features which were assigned to the NHₓ moieties (FIG. 3). The bands located at 3190 and 3350 cm⁻¹ were assigned respectively to the N—H and N—H₂ stretching mode vibration in amines and amides, while the band at 3440 cm¹ was attributed to the O—H vibration mode of the silanol groups. As it was not possible from our FTIR analysis to clearly distinguish between the amide and amine groups, these data were further quantified using XPS following the derivatization reaction with chlorobenzaldehyde (Chevallier P, Castonguay M, Turgeon S, Dubrulle N, Mantovani D, McBreen P H, Wittmann J C, Laroche G (2001) J Phys Chem B 105: 12490). These experiments showed that the amount of surface amino groups was 2.5%, corresponding approximately to 0.5-2 amine/nm² (Gauvreau V, Chevallier P, Vallieres K, Petitclerc E, Gaudreault R C, Laroche G (2004) Bioconjugate Chem 15: 1146), and was thus adequate for surface conjugation. These data were recorded one week after the layer of Formula I deposition, thus confirming that the remaining amine concentration was stable and no longer susceptible to aging effects.

### Topography Analyses and Evaluation of The Mechanical Properties of The Layers

Topographies of the layer of Formula I (deposition without N₂O) and layer of Formula II (deposition with N₂O) on silicon wafers were observed by AFM. The AFM images clearly showed that the layer of Formula I was more porous because of its columnar structure. In contrast, the layer of Formula II appeared to be very dense, with no columnar growth. Accordingly, the surface roughness Rᵣₘₛ of the layer of Formula I was 42 nm, while that of the silica-like coating was 1.3 nm.

The mechanical properties of the layers were assessed by AFM nanoindentation measurements. As expected, these experiments determined the micro-hardness values of 0.3 GPa and 5 GPa for the layer of Formula I and layer of Formula II, respectively. The hardness measured for the layer of Formula I was typical of plastic materials (˜0.3 GPa) (Korsunsky. A. M, McGurk. M. R, Bull. S. J, Page. T. F (1998) Surf Coat Tech 99: 171), whereas the hardness of the layer of Formula II was an order of magnitude higher and was more comparable to that of glass (˜9 GPa) (Korsunsky. A. M, McGurk. M. R, Bull. S. J, Page. T. F (1997) Surf Coat Tech 99: 171).

### Results and Discussion of the Anti-Fog Coating Composition Characterization

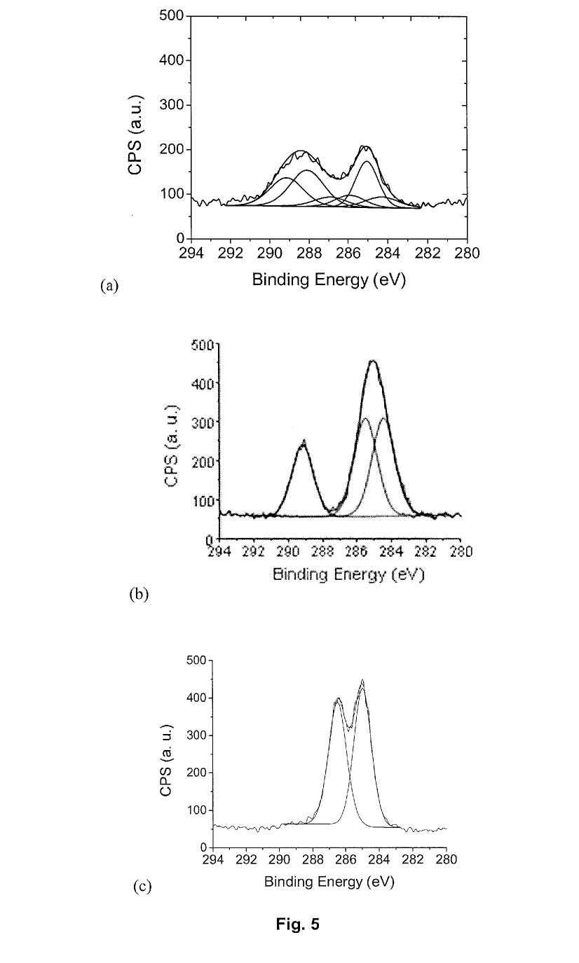

ATR-FTIR was used to characterize the two successive PEMA and PVA polymer layers to construct the anti-fog layer. As is shown in FIG. 4, the FTIR spectrum of the spin-coated PEMA onto the plasma-deposited multilayer exhibited a peak at 1857 cm⁻¹, attributed to the C═O stretching mode vibration of the anhydride functionalities (Bryjak M, Gancarz I, Pozniak G, Tylus W (2002) Europ. Polym. J. 38: 717). Similarly, the additional PVA coating enabled us to record a A FTIR spectrum a feature characteristic of O—H groups close to 3350 cm⁻¹, which may have occurred from either the alcohol groups in the PVA or the carboxylic functionalities resulting from the reaction between the PEMA and the PVA. Overall, the ATR-FTIR measurements reveal the presence of each deposited layer as well as the polycarbonate substrate features, confirming that the multilayer thickness was beneath the depth of analysis probed by ATR-FTIR measurement (˜1 μm).

These ATR-FTIR data were further confirmed through XPS. The XPS survey spectrum of spin-coated PEMA (not shown) exhibited a carbon-to-oxygen ratio of two, in agreement with the stoichiometric chemical structure of the polymer. Further spin coating with PVA also produced an XPS survey spectrum (not shown) with a carbon-to-oxygen ratio of two, which correlated with the results discussed above. None of these spectra exhibited Si features, thereby confirming complete coverage of the outermost layer of Formula I underneath. High resolution XPS provided further data on the entire spin-coating process (FIG. 5). On one hand, the C1s high resolution XPS spectrum performed on the outermost layer of Formula I (prior to any spin coating) displayed a profile requiring six bands to allow for appropriate curve fitting (FIG. 5a); however, these calculated features were not assigned because of the complexity of plasma-deposited polymer films that render difficult any consistent peak attribution. The HR C1s spectrum of the PEMA was fitted with three components at 285.0, 286.0 and 289.2 eV which were assigned to C—C/CH, C—CO and O—C═O (anhydride groups) (FIG. 5b). The HR C1s spectrum of the further coating step evidenced the PVA) grafting by the characteristic band at 286.5 eV corresponding to the C═O in alcohol (FIG. 5c), This is in agreement with Xiuming J, Cui L, Jianwei L (2009) React Funct Polym 69: 619. The absolute integrated intensity of the C1s XPS spectrum of the layer of Formula I was approximately 40% of that measured for both the PEMA and PVA HR C1s XPS spectra, thus indicating a less “polymeric” character for the plasma-deposited film with respect to “real” polymers.

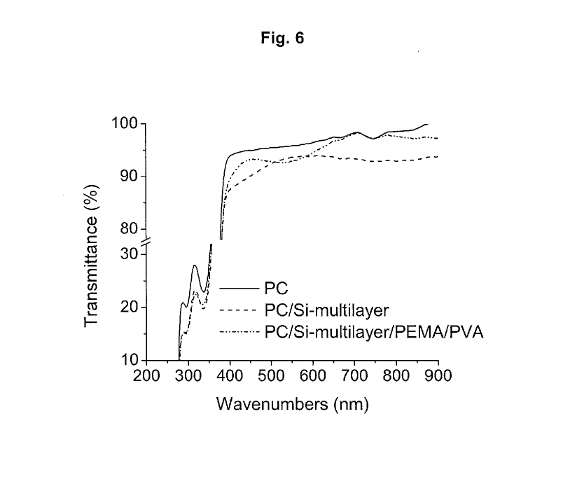

The transparency of the entire coating assembly in the visible region was compared to that of as-received polycarbonate, which is currently used in optical components because of its excellent light transmittance capacity and mechanical properties. The curves presented in FIG. 6 show that both the combination of Formula I/Formula II/Formula I multi-layers and the entire anti-fog coating only slightly affected the polymer's transparency, with a maximum decrease of 5-6% depending on the wavelength considered.

### Example 10

### Assessment of Optical Properties

The anti-fog properties of the coating was observed by putting the coated substrate in a cold room for one hour (−18° C.), and bringing them back into room temperature, as under such conditions, the thermal gradient provides good conditions of drop-moisture formation. It was observed that the surface coated with the layer resulting from contacting the hydrophilic polymer (namely the PC/Si-multilayer/PEMA/PVA sample) remained clear during the cold/warm transition. In contrast, the other investigated surfaces, namely (a) clean polycarbonate, (b) polycarbonate coated with the combination of Formula I/Formula II/Formula I multi-layers, or (c) polycarbonate coated with the combination of Formula I/Formula II/Formula I/PEMA, all exhibited the presence of fog when subjected to the same temperature gradient. Also, the sole presence of PEMA, despite leading to an increase of the surface energy, was not sufficient to promote anti-fog properties.

These qualitative data were further confirmed using an ASTM procedure as described in ASTM, F659-06, Standard Specification for Skier Goggles and Faceshields—Annex A1. Test method for fogging properties, in ASTM. 2004: West Conshohocken, Pa., USA, p. 145 that measures the evolution of light transmission over time of samples exposed to a humid atmosphere. According to this protocol, a sample is considered to present anti-fog properties when it maintains a light transmission of 80% after 30 seconds of exposure to humidity. It was observed that the clean polycarbonate substrate fogged up immediately following exposure to the humid atmosphere, whereas the polycarbonate coated with the anti-fog coating maintained a 60% light transmittance after the projected 30 seconds of exposure, as stated in the ASTM protocol. Thus the anti-fog coating displayed light transmission close to 90% for 15 seconds of exposure to humidity. Finally, the use of the anti-fog coating composition also revealed an improvement of light transmission decay when applied to the polycarbonate substrate. These values were calculated to be 1.341 s⁻¹ and 0.0313 s⁻¹ for the non-coated polycarbonate substrate and the polycarbonate substrate coated with the anti-fog coating, respectively. In light of these findings, the anti-fog coating illustrated anti-fog properties which could be used in applications such as eyewear, swimming goggles, lenses, etc.

1. An anti-fog coating for a surface of a substrate comprising in order:
a layer of Formula I: SiOxCyNz:H;
a layer of Formula II: SiOw:H;
a layer of Formula I: SiOxCyNz:H;
a layer resulting from contacting a polyanhydride polymer with the outermost layer of Formula I; and
a layer resulting from contacting a hydrophilic polymer;
wherein x, y and z in each layers of Formula I are the same or different.

2. The anti-fog coating according to claim 1 wherein said layers of Formula I are each independently obtained by plasma deposition of a siloxane or silazane.

3. The anti-fog coating according to claim 1 wherein said layers of Formula I are each independently obtained by plasma deposition of hexamethyldisiloxane (HMDSO), polydimethylsiloxane (PDMS), tetramethylcyclotetrasiloxane (TMCTS), octamethylcyclotetrasiloxane, tetraethylorthosilicate (TEOS), polyhydrogenmethylsiloxane or tetramethyldisiloxane.

4. The anti-fog coating according to claim 1 wherein said layer of Formula II is obtained by plasma deposition of a siloxane or a silane.

5. The anti-fog coating according to claim 1 wherein said layer of Formula II is obtained by plasma deposition of hexamethyldisiloxane (HMDSO), tetramethylcyclotetrasiloxane (TMCTS) or tetraetoxysilane (TEOS).

6. The anti-fog coating according to claim 1, wherein the polyanhydride polymer is selected from poly(ethylene-alt maleic anhydride), poly(maleic anhydride-alt-1-octadecene), polyisobutylene-alt-maleic anhydride), poly(styrene-alt-maleic anhydride), poly(methyl vinyl ether-alt-maleic anhydride) and poly[(isobutylene-alt-maleic acid, ammonium salt)-co-(isobutylene-alt-maleic anhydride).

7. The anti-fog coating according to claim 1, wherein the hydrophilic polymer is selected from polyvinyl alcohol, partially hydrolyzed polyvinyl ester, partially hydrolyzed polyvinyl ether and cellulose derivatives.

8. A process for preparing an anti-fog coating to a surface of a substrate comprising:
a) depositing a layer of Formula I: SiOxCyNz:H, on the surface of the substrate;
b) depositing a layer of Formula II: SiOw:H, on the layer of Formula I;
c) depositing a layer of Formula I: SiOxCyNz:H, on the layer of Formula II; and
d) adding a polyanhydride polymer on the outermost layer of Formula I; and
e) adding a hydrophilic polymer on the polyanhydride polymer;
wherein x, y and z in each layers of Formula I are the same or different.

9. The process according to claim 8 wherein said layers of Formula I and Formula II are obtained by plasma deposition.

10. The process according to claim 8 wherein said layers of Formula I and Formula II are obtained using dielectric barrier discharge procedure.

11. The process according to claim 8 wherein said layers of Formula I are each independently obtained by plasma deposition of a siloxane or silazane in the presence of a carrier gas containing nitrogen.

12. The process according to claim 8 wherein said layer of Formula II is obtained by plasma deposition of a siloxane or a silane in the presence of a carrier gas containing nitrogen and an oxidizing gas.

13. The process according to claim 12 wherein the ratio of oxidizing gas/siloxanes or silanes is about 12.

14. The process according to claim 8 wherein said steps a) and b) are repeated before step c).

15. The process according to claim 8, further comprising the step of cross-linking said anhydride and hydrophilic polymers independently after their respective steps of addition or after both polymers have been applied.

16. The process according to claim 8 wherein steps d) and e) are in one step.

17. A substrate having an anti-fog coating thereon, said coating comprising in order:
a layer of Formula I: SiOxCyNz:H;
a layer of Formula II: SiOw:H;
a layer of Formula I: SiOxCyNz:H;
a layer resulting from contacting a polyanhydride polymer with the outermost layer of Formula I; and
a layer resulting from contacting a hydrophilic polymer;
wherein x, y and z in each layers of Formula I are the same or different.

18. The substrate according to claim 17, wherein said substrate includes polymers, glass, ceramics, metals, composites and combinations thereof.
